(19) United States
(12) Patent Application Publication
(10) Pub. No.: US 2009/0223881 A1
(43) Pub. Date: Sep. 10, 2009

(54) Reverse Osmosis System with Dual Water Intake

(76) Inventor: Peter Villeneuve, Reno, NV (US)

Correspondence Address: Gray Robinson;ATTN: STEFAN V. STEIN/ IP DEPT., 201 N. Franklin Street, Suite 2200, Post Office Box 3324, TAMPA, FL, 33601-3324, US

(21) Appl. No.: 12/041,898

(22) Filed: Mar. 4, 2008

(51) Int. Cl. C02F 1/44

(52) U.S. Cl. 210/103; 210/321.64; 210/170.11

(57) ABSTRACT

Disclosed is an improved multi-state reverse osmosis system with dual water inlets for improving filtration efficiency. More specifically, the system includes a pressure vessel with a series of semi permeable membranes. A seawater inlet is included at both a first end of the vessel and at an intermediate location. By re-supplying seawater at the intermediate location, a minimum seawater pressure is maintained throughout the entire length of the vessel. This, in turn, results in increased filtration efficiency.

### BACKGROUND OF THE INVENTION

1. Field of the Invention

This invention relates to a reverse osmosis system with increased filtration efficiencies. More particularly, the present invention relates to a multi stage reverse osmosis system with dual water inlets.

2. Description of the Background Art

Governments and municipalities are increasingly turning to reverse osmosis separation processes to meet rising demands for fresh water. Reverse osmosis processes are widely known for use in removing salt and other minerals from seawater or brackish water. The result is a purified naturally occuring water that can be readily used in a variety of applications.

Seawater reverse osmosis is typically carried out over a number of stages. These stages may, for example, include an intake stage, a pre-treatment stage, a high pressure pump stage, one or more membrane stages, a re-mineralization and pH adjustment stage, and finally a disinfection stage.

Salt and other minerals are separated from water in the membrane stages. As is known in the art, this involves forcing seawater through a series of semi-permeable membranes. This creates a higher solute concentration on the upstream side of the membrane stages and a lower solute concentration on the downstream side. The high pressure pump is employed in pressurizing the upstream seawater to overcome inherent osmotic pressures. For most seawater applications, pressures of between 600 to 1000 psi are utilized. This pressure decreases as the water travels downstream through sequential membranes.

Although the above described reverse osmosis system is sufficient to generate pure water, it has inherent inefficiencies. Namely, as the seawater traverses the various membranes it gradually loses pressure. As a consequence, there is a considerable drop in the velocity of the water traversing the membranes and a commensurate drop in filtration efficiency. This, in turn, means that most of the impurities are removed by the initial membranes of the series and that very little purification is carried out in the final membranes.

Various efforts have been made over the years to compensate for inefficiencies in the reverse osmosis process. For instance, U.S. Pat. No. 5,207,916 to Goheen et al. discloses a single RO membrane having a double-pass design using two banks of membranes in series. Liquid is initially pumped into a first bank of RO membranes. On the downstream side of the first bank of membranes, the liquid is conducted into a hydraulic turbocharger to re-elevate the pressure of the liquid prior to entering the second bank of membranes.

The use of multiple pumps in an reverse osmosis system is also known. For instance, U.S. Pat. No. 4,160,727 to Harris, Jr. discloses a method for purifying and dispensing water that utilizes staged RO membranes. The method pumps water into a first RO membrane. The permeate from this first RO membrane is then routed to a second pump, sending the liquid into a second RO membrane. Two feed water supplies are included for the two RO membranes.

Likewise, U.S. Pat. No. 4,808,287 to Hark discloses a water purification process which includes a two stage RO process, wherein water is initially pumped into a first RO unit, then pumped into a second RO unit. The system also maintains proper osmotic pressure relative to the discharge pressure and flow pressure of the first pump.

Finally, U.S. Pat. No. 6,139,740 to Oklejas discloses an apparatus for improving the efficiency of an RO system which utilizes a hydraulic turbocharger to increase the pressure of water between a first RO chamber and a second RO chamber. It is also disclosed that the turbine can be utilized for recovering energy from the process.

Although some of the above referenced inventions may enjoy slightly increased filtration efficiencies, none contemplate achieving increased pressurization and filtration efficiency via the addition of a secondary water inlet.

### SUMMARY OF THE INVENTION

It is therefore one of the objectives of this invention to provide for increased filtration efficiency in a multi stage reverse osmosis process by providing an additional water inlet at a point intermediate the first and last membranes.

It is another object of this invention to increase the supply of water to a multi stage reverse osmosis system to thereby maintain increased pressurization throughout the various stages.

It is still yet another object of this invention to provide a computer control to a multi stage reverse osmosis system, wherein variations in the amount of purified water created can be compensated for by increasing the amount of water added downstream between first and final reverse osmosis stages.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a schematic view of the reverse osmosis system of the present invention.

FIG. 2 is an alternative embodiment of the reverse osmosis system of the present invention.

Similar reference characters refer to similar parts throughout the several views of the drawings.

### DETAILED DESCRIPTION OF THE PREFERRED EMBODIMENT

The present invention relates to an improved multi-stage reverse osmosis system with dual water inlets for improving filtration efficiency. More specifically, the system includes a pressure vessel with a series of semi permeable membranes. A water inlet is included at both a first end of the vessel and at an intermediate location. By re-supplying water at the intermediate location, a minimum water pressure is maintained throughout the entire length of the vessel and increased efficiencies are realized.

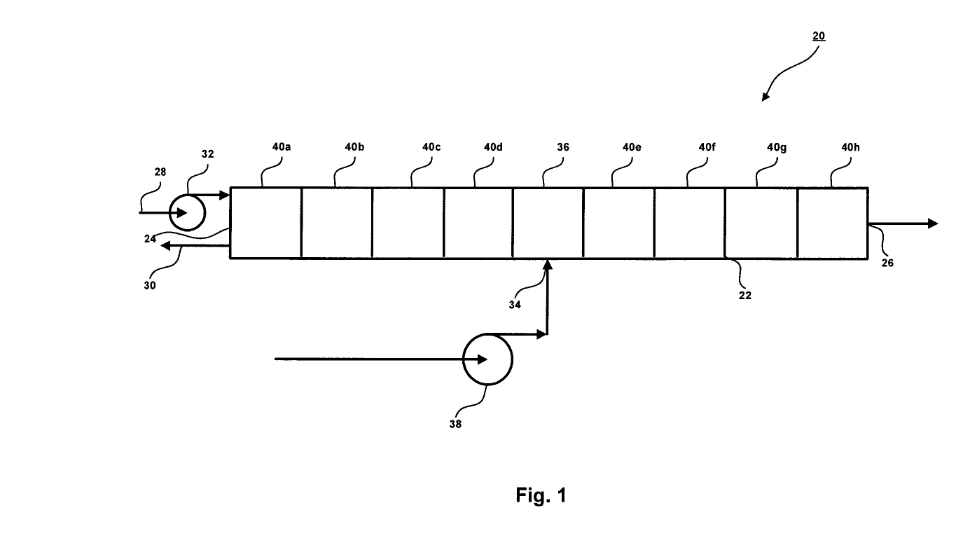

One embodiment of the reverse osmosis system 20 of the present invention is illustrated in FIG. 1. As is typical, system 20 includes an elongated pressure vessel 22 with first and second ends (24 and 26, respectively). Water is delivered to the first end 24 of vessel 22 via a first sea water intake 28 with the resulting purified being likewise removed from the first end 24 via an axial conduit 30. The water used in the system will be seawater or perhaps brackish water. Solute, containing the salt and other minerals removed from the seawater, are extracted via the second end 26 of vessel 22.

System 20 achieves seawater filtration via a series of semi-permeable membranes (40a, 40b, 40c, 40d, 40e, 40f, 40g, and 40h) positioned within pressure vessel 22. As is known in the art, these membranes (40a, 40b, 40c, 40d, 40e, 40f, 40g, and 40h) can be radially disposed in a concentric fashion about the axial conduit 30. This construction allows seawater to pass inwardly toward the axial conduit 30 in a radial direction. The result is that the purified and de-mineralized water is delivered to the axial conduit 30 and is extracted from first end 24.

In order to ensure that the seawater delivered via first intake 28 is sufficiently pressurized, a high pressure pump 32 is provided. In the preferred embodiment, pump 32 ensures that the seawater supplied via intake 28 is pressurized to between approximately 600 to 1000 pounds per square inch. Pressurizing first intake 28 is necessary to ensure proper operation of the downstream membranes as well as to overcome the inherent osmotic pressure of the system.

In accordance with the present invention, a second water intake 34 is included along the intermediate extent of vessel 22. In the embodiment depicted in FIG. 1, a total of eight membranes (40a, 40b, 40c, 40d, 40e, 40f, 40g, and 40h) are included within vessel 22, and the second water intake 34 is included at a midpoint between the membranes (i.e. after 40d but before 40e). More specifically, second intake 34 feeds into an intermediate chamber 36 of vessel 22.

A second high pressure pump 38 is likewise provided for pressurizing the second seawater intake 34. In the preferred embodiment, pump 38 pressurizes the seawater to between approximately 600 to 1000 pounds per square inch.

It has been discovered that by providing this additional intake 34 at a downstream location, the pressure of the water can be more uniformly maintained throughout the entire length of vessel 22. By contrast, without an additional intake, the pressure and velocity of water within vessel 22 would quickly diminish across the multiple membranes. In the preferred embodiment, a balanced flow is achieved by ensuring that the volume of water supplied at the second input 34 is equal to the amount of fresh water extracted from conduit 30.

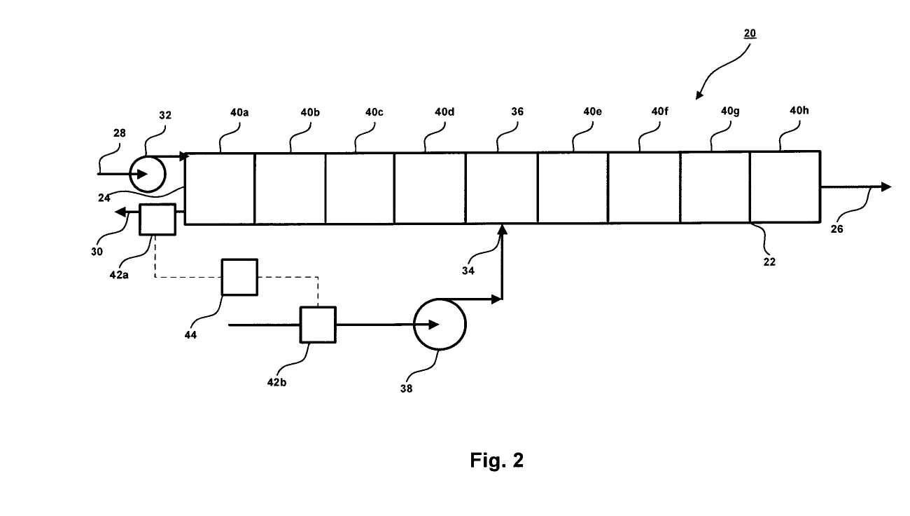

In accordance with a further embodiment of the present invention, this balanced flow is maintained via flow meters and a controller. This embodiment is depicted in FIG. 2. Flow meters 42 are associated with conduit 30 and second intake 34. Specifically, a first flow meter 42a is operatively coupled to the fresh water conduit 30 and a second flow meter 42b is operatively coupled to the second high pressure pump 38 and second intake 34. The first flow meter 42a monitors the volume of water leaving vessel 22 as fresh water, and the second flow meter 42b monitors the volume of water supplied to the second intake 34.

A controller 44 is operatively associated with the flow meters (42a and 42b) and pump 38 and is used in maintaining an equilibrium between the freshwater generated by system 20 and the amount of seawater supplied to the second intake 34 via pump 38.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention

What is claimed is:

1. A reverse osmosis system for use in de-mineralizing sea water comprising:
a pressure vessel having a first end, a second end, and an intermediate extent therebetween;
a series of semi-permeable membranes positioned within the pressure vessel, the membranes being used in de-mineralizing the seawater;
a first high pressure pump for delivering a first supply of seawater to the first end of the pressure vessel at a pressure of between approximately 600 to 1000 pounds per square inch;
a first flow meter for monitoring the volume of de-mineralized water produced by the vessel;
a second high pressure pump for delivering a second supply of seawater to the intermediate extent of the pressure vessel at a pressure of between approximately 600 to 1000 pounds per square inch;
a second flow meter operatively coupled to the second high pressure pump for monitoring the volume of seawater delivered to the intermediate extent of the pressure vessel;
a controller operatively associated with the flow meters and the second pump for maintaining an equilibrium between the de-mineralized water produced by the vessel and the volume of water supplied to the intermediate extent.

2. A reverse osmosis system for use in de-mineralizing water comprising:
a pressure vessel having a first end, a second end, and an intermediate extent therebetween;
a series of semi-permeable membranes positioned within the pressure vessel, the membranes being used in de-mineralizing water delivered to the first end of the vessel;
a pump for delivering an additional supply of water to the intermediate extent of the pressure vessel;
wherein by supplying additional water at the intermediate extent a uniform pressure is realized across the entire pressure vessel and increased filtration efficiencies are realized.

3. The reverse osmosis system as described in claim 2 wherein flow meters are used to determine the amount of de-mineralized water produced by the vessel and the amount of water supplied to the intermediate extent and wherein a controller is used to ensure a balanced flow between the two.

4. The reverse osmosis system as described in claim 2 wherein the system is used for seawater de-mineralization and wherein seawater is delivered to the first end of the vessel at a pressure of between 600 to 1000 pounds per square inch.

5. The reverse osmosis system as described in claim 2 wherein the membranes are wound about an axis that is concentric with the axis of the vessel.
